(19) United States
(12) Patent Application Publication
(10) Pub. No.: US 2014/0140080 A1
(43) Pub. Date: May 22, 2014

(54) LIGHT RING FOR AN AIRCRAFT CABIN WINDOW

(71) Applicant: MSA Aircraft Products Ltd., San Antonio, TX (US)

(72) Inventor: Nicholas C. Mohat, San Antonio, TX (US)

(21) Appl. No.: 13/908,376

(22) Filed: Jun. 3, 2013

Related U.S. Application Data
(60) Provisional application No. 61/658,144, filed on Jun. 11, 2012.

(51) Int. Cl. B64D 47/02

(52) U.S. Cl. CPC B64D 47/02
USPC 362/471

(57) ABSTRACT

In an aircraft having an A/C exterior and an A/C interior, an assembly for illuminating an A/C window on the interior. The assembly comprises an A/C interior panel having an inner surface and an outer surface configured with walls defining a window opening. A substantially opaque inner collar is generally configured to the shape of the window opening also has an inner edge and an outer edge. The inner collar is adapted to engage the A/C interior panel adjacent the window opening. A window shade unit is provided and has an inner lens and a substantially opaque moveable shade. A light diffuser member, such as a milky colored at least partly light transparent sheet of plastic, is configured to the shape of the window opening. The light diffuser engages the opaque inner collar near the outer edge thereof and lays adjacent the inner lens of the window shade unit. Coupling members are used to couple the window unit to the inner collar and an illumination source configured to lay adjacent the collar and an outer surface of the light diffuser, so as to illuminate the window from the outside in, through the light diffuser when the light source is illuminated, so as to cast light into the A/C interior.

This application claims priority from and the benefit of U.S. Patent Application Ser. No. 61/658,144, filed Jun. 11, 2012.

### FIELD OF THE INVENTION

Windows for aircraft interiors, more specifically, a window assembly including lighting elements.

### BACKGROUND OF THE INVENTION

Known lighting assemblies used in aircraft interiors are typically independent from the window structurally and functionally.

### SUMMARY OF THE INVENTION

In an aircraft having an A/C exterior and an A/C interior, an assembly for illuminating an A/C window on the interior. The assembly comprises an A/C interior panel having an inner surface and an outer surface configured with walls defining a window opening. A substantially opaque inner collar is generally configured to the shape of the window opening also has an inner edge and an outer edge. The inner collar is adapted to engage the A/C interior panel adjacent the window opening. A window shade unit is provided and has an inner lens and a substantially opaque moveable shade. A light diffuser member, such as a milky colored at least partly light transparent sheet of plastic, is configured to the shape of the window opening. The light diffuser engages the opaque inner collar near the outer edge thereof and lays adjacent the inner lens of the window shade unit. Coupling members are used to couple the window unit to the inner collar and an illumination source configured to lay adjacent the collar and an outer surface of the light diffuser, so as to illuminate the window from the outside in, through the light diffuser when the light source is illuminated, so as to cast light into the A/C interior.

The illumination source, in one embodiment, is a fluorescent tube, in one embodiment, a cold cathode fluorescent tube. The cold cathode fluorescent tube may be controlled by controllers accessible to a passenger seated adjacent to the assembly or controlled by controllers remote from the passenger. The fluorescent tube is typically shaped to conform to the window opening but may have slightly larger major and minor dimensions.

### BRIEF DESCRIPTION OF THE DRAWINGS

FIG. 1 is a partial cutaway view of Applicant's aircraft cabin window, including the light ring.

FIG. 1A is an exploded view of Applicant's window illumination assembly.

FIG. 2 is a partial cutaway side view of Applicant's novel aircraft cabin window assembly.

FIGS. 3 and 3A are detail views of Applicant's light emitting element or light ring, apart from the window assembly, FIGS. 3 and 3A showing some exemplar dimensions in inches.

FIG. 4 illustrates an aircraft equipped with Applicant's multiple window assemblies.

### DETAILED DESCRIPTION OF THE PREFERRED EMBODIMENT

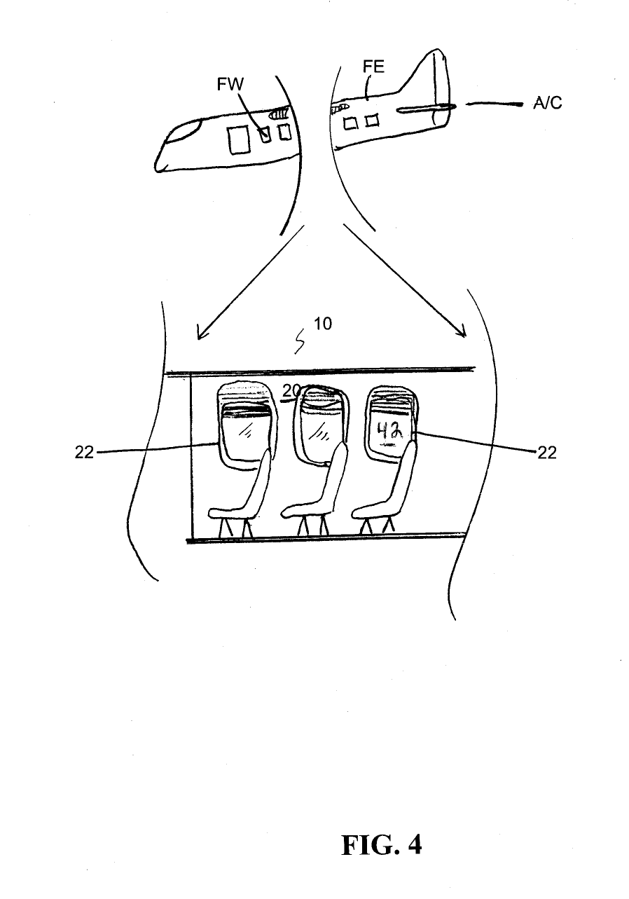

Aircraft interiors typically include aircraft interior side walls, floors, and ceiling panels (see FIG. 4). Typically the side wall panels are curved to conform to the curved exterior of the aircraft fuselage. Typically, the cabin of the aircraft has windows allowing light from the exterior to illuminate the interior. Typically the aircraft windows include shades that may be operated by the passengers, the shades being operated manually or electrically (through a control panel).

In some cases, especially in high end (expensive) aircraft, such as corporate jets and the like, the shades are captured and substantially sealed between an inner and an outer lens in a modular unit, such as those manufactured by MSA Aircraft Interior, 10000 Iota Drive, San Antonio, Tex. 78217, which may be seen at www.msaaircraft.com. These modular, cassette or self-contained window units typically include a frame, a mask, inner lens, outer lens, reveal a shade rail, a manual or electrical system to drive the shade rail, and a shade.

The shade may be driven manually through a handle accessible to a passenger or may be electronically controlled having a control member accessible to a seated passenger adjacent the window, and powered by the aircraft electrical system.

Some features of such modular or cassette windows are disclosed in the following patents and/or publication incorporated herein by reference: US Patent Publication No. US 2003/0085001 and U.S. Pat. No. 4,679,610.

One such modular or cassette window shade unit, which may be used as disclosed herein, is Part No. MSA-05-MD8-1800A or 3700A, available from Assignee. The 3700A is a double opening shade that can be supplied with variations ranging from 30 inches to 42 inches. The 1800A is a single opening shade.

In a preferred embodiment of Applicant's novel aircraft cabin window assembly disclosed herein, a light emitting element is provided as an accent to the lighting ensemble of an aircraft interior, which light emitting element is typically ring, oval or rectangular shaped, and forms an edge surrounding an opening in the side wall of the side wall panels of the interior. The opening accented is the interior window opening. The ring-like element may comprise light emitting elements, such as an LED string, electroluminescence member or incandescent, fluorescent, cold cathode or other suitable light emitting member surrounding the side wall window opening and generally conforming in shape thereto.

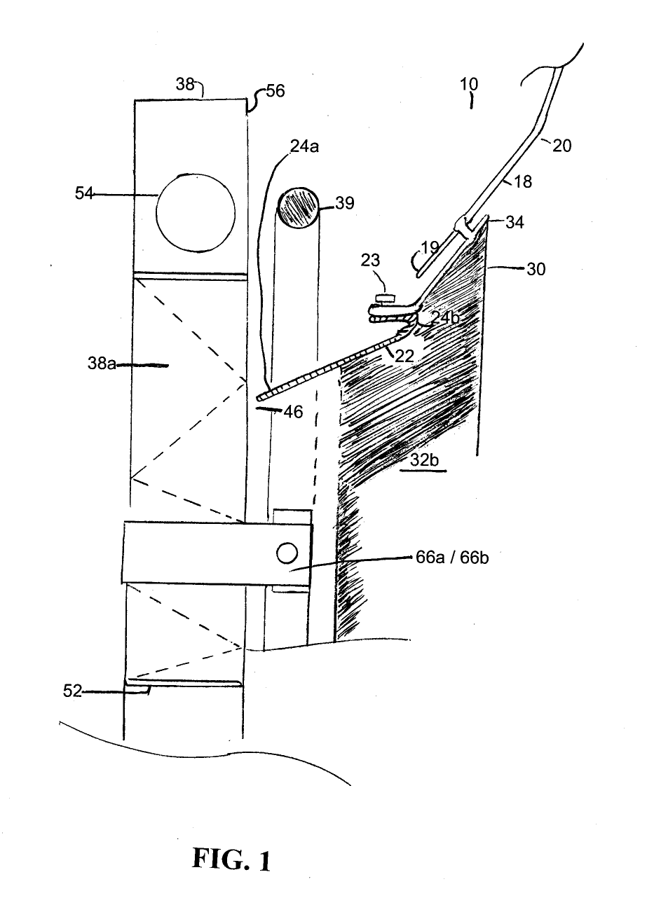

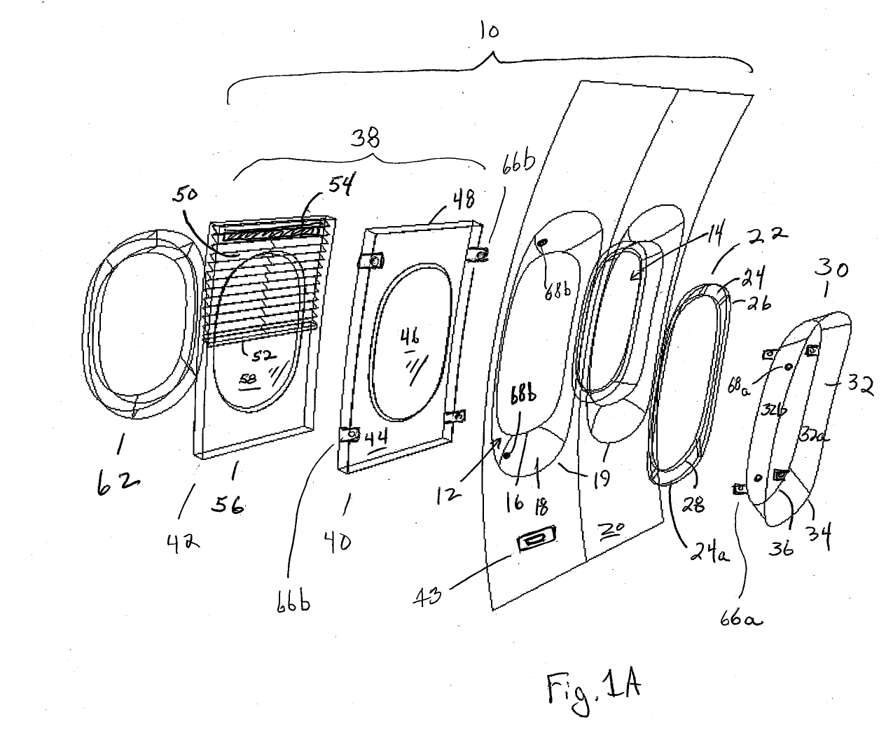

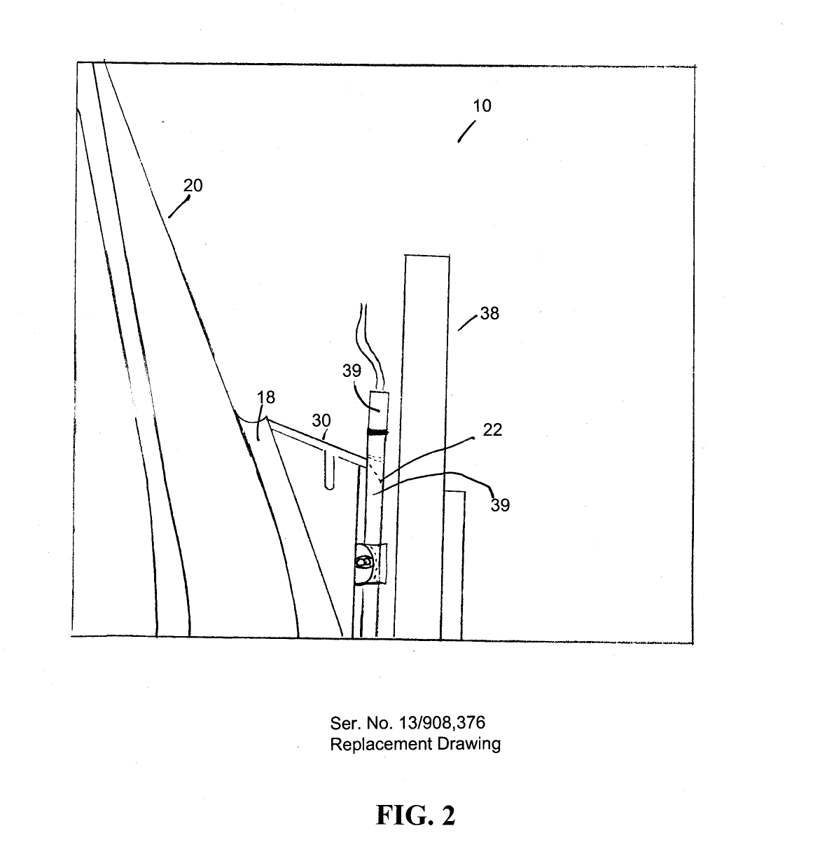

FIGS. 1-4 illustrate a preferred embodiment of Applicant's aircraft cabin window assembly 10, sometimes hereinafter referred to as window accent assembly 10. Applicant's aircraft window may include a side wall panel 20, such as a standard 747-81 Boeing side wall panel. This side wall panel is curved and may include one or two or more adjacent cutouts 12/14 provided for light to pass therethrough into the interior of the aircraft. Cutouts 12/14 are shaped in ways known in the art, but may be typical oval or rectangular. Each cutout 12/14 is defined by an outer edge 16 and, typically, a recessed portion 18 of a side wall panel 20. The side wall panels are typically made from lightweight composite and may take any suitable configuration, but comprise typically, in one embodiment, the interior side wall of an aircraft, such as a Boeing 747.

It is seen that there may be two cutouts 12/14, but there may be more or less. Cutouts 12/14 generally conform to the fuselage window FW on the exterior FE of the fuselage of the aircraft. A modular window assembly 38 is adapted to engage the outer walls of side wall panel 20, so as to be located between side wall panel 20 and the inner surface of the fuselage exterior FE, including the fuselage exterior window FW. An inner collar 30 is seen to seat and lay adjacent the recessed portion(s) 18 of the side wall panel in a manner that will capture a light diffuser 22 adjacent the inner collar and the recessed walls as illustrated in FIGS. 1 and 1A. An outer collar 62 may engage an outer surface of the modular window assembly 38 and includes walls configured to engage the outer fuselage window FW of the aircraft in a manner known in the art.

Light diffuser member or light diffuser 22 is seen to include a body 24 configured with an outer surface 24a and inner surface 24b, an inner edge 26, and an outer edge 28. Light diffuser 22 may have outwardly tapered walls is and seen to be configured so that an outer edge 28 generally takes the shape of cutouts 12/14 and illuminated outer edge or portion 26 conforms to inner perimeter 19 of recessed portion 18. Light diffuser 22 has adjacent thereto, a light transmitting ring—or an illumination member 39—comprising an LED string, electroluminescence, incandescent elements, fluorescent elements, including cold cathode fluorescent tubes, or other suitable light emitting members configured to provide all or part of an illuminated outer edge or portion 26 and powered, through control elements, by the aircraft's power system, such as the aircraft's electrical system, and through a control panel 41 placed adjacent the passenger seat adjacent the window, or remote, such as in the aircraft cockpit.

One such illumination member may be an EL (electroluminescent) wire from EL Wire Pros. The EL wire is capable of engaging the 28 volt DC electricity available from the aircraft power system. An inverter is provided to convert the 28 volt DC to 94 volt AC at 400 Hz. A processor may be provided to vary the 400 Hz driving the EL wire comprising the illuminated inner edge 26 at a variable frequency. The variable frequencies may be used, through the controller, to increase or decrease the brightness of the illuminated inner edge 26 comprising an EL wire configured as set forth herein.

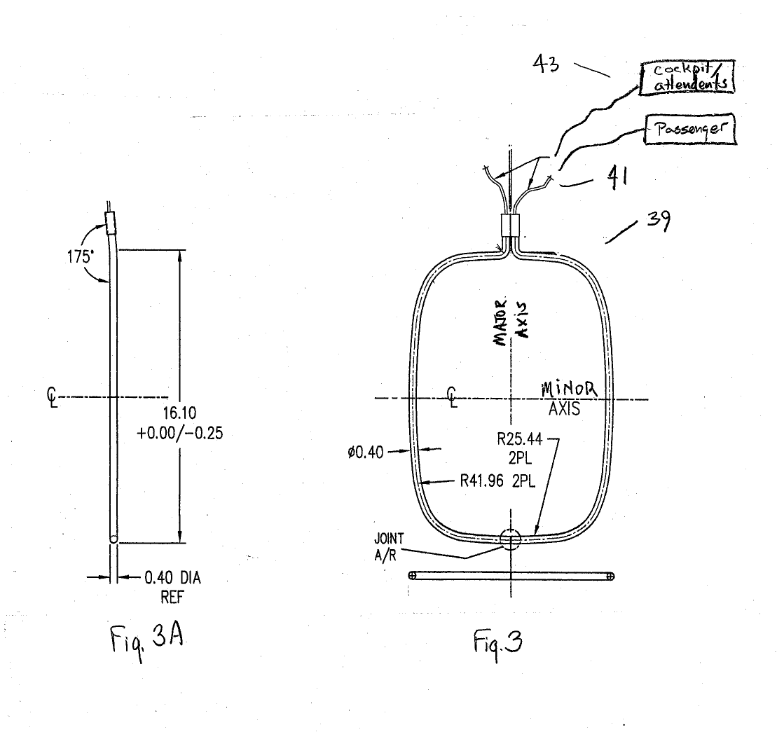

Another such illumination member may be a cold cathode fluorescent light tube as illustrated in FIGS. 3 and 3A, shaped with a major and minor axes. Typically the major and major axes will be slightly larger than the major or minor axes of the inner edge of the window opening. Leads 41 may be wired to controllers 43, such controls adjacent the passenger seat or remotely located, so as to energize the illumination source 39.

Body 24 is adapted to conform to inner collar 30, which in turn is adapted to conform to the recess. Inner collar 30 may be partly or fully upholstered in ways known in the art. Inner collar 30 typically includes a body 32 having an inner surface 32b and an outer surface 32b. An inner edge 34 is provided as is an outer edge 36 defining an opening. Surfaces 32a/32b and edges 34/36 are designed to, when placed near light diffuser 22, disclose conceal visible ring-shaped light element 39, but to enable illumination source 39 to illuminate the window through light diffuser 22. In such a fashion, when the aircraft interior is dark, light emitting element 39 will emit light through diffuser 22 to give a pleasing “glow” outlining the window.

Modular window assembly 38 may include an inner shade box 40 and an outer shade box 42, shade boxes 40/42 conformed to mate with one another so as to seal a shade 50, such as a pleated shade, between an inner lens 46 and an outer lens 58. Inner shade box 40 may include a mask 44 adjacent the inner lens 46, which mask 44 is generally opaque and has an inner border that conforms to the shape of cutouts 12/14, but is usually smaller. Boxes 40/42 and elements, including frame and lens, contained therein may be curved as necessary to conform to the curve shape of side wall panel 10. Inner shade box 40 includes frame or perimeter elements 48 as known in the art to engage cooperating frame or perimeter elements 56 of outer shade box 42. Modular window assembly 38 typically has a moveable lower shade rail 52 and a drive assembly 54, typically adjacent an upper shade rail, which may comprise part of frame or perimeter elements 56. The drive assembly may be manual, electric or other ways known in the art. Shade 50 may be a single or dual shade assembly, such as a dual shade assembly disclosed in US Patent Publication No. US 2003/0085001, incorporated herein by reference. Outer lens 58 engages the frame and may include a reveal 60, which is opaque and generally conforms to the shape of outer collar 62.

The one such modular window assembly 38 that may be used is MSA-005-CM747-1600A-PM0, a shade cassette with a frame that incorporates the inner reveal and includes an adapter flange to mate with an existing Boeing inner collar (see FIG. 1).

Modular window assembly 38 may engage inner collar 30 at bracket pairs 66a/66b, the first of the pair attached to the window assembly and the second of the pair typically projecting outward from the outer edge 36 of inner collar 30, where a fastener may be used to engage the bracket pairs. Snap boss/receiving orifice 68a/68b may be used to engage outer wall of inner collar 30 to side wall panel 20, in one embodiment, to the recessed portions 18 thereof. Controllers 43 may be passenger accessible, such as adjacent the passenger seat and the window assembly or may be remote, such as located in the cockpit or in the attendant area of the aircraft.

Although the invention has been described with reference to a specific embodiment, this description is not meant to be construed in a limiting sense. On the contrary, various modifications of the disclosed embodiments will become apparent to those skilled in the art upon reference to the description of the invention. It is therefore contemplated that the appended claims will cover such modifications, alternatives, and equivalents that fall within the true spirit and scope of the invention.

1. In an aircraft having an A/C exterior and an A/C interior, an assembly for illuminating an A/C window on the aircraft interior, the assembly comprising:
an A/C interior panel having an inner surface and an outer surface configured with walls defining a window opening;
a substantially opaque inner collar generally configured to the shape of the window opening having an inner edge and an outer edge, the inner collar adapted to engage the A/C interior panel adjacent the window opening;
a window shade unit having an inner lens and a substantially opaque moveable shade;
a light diffuser member configured to the shape of the window opening, the light diffuser for engaging the opaque inner collar near the outer edge thereof and to lay adjacent the inner lens of the window shade unit;
coupling members to couple the window unit to the inner collar; and
an illumination source configured to lay generally adjacent or near the collar and an outer surface of the light diffuser, so as to illuminate the window from the outside in, through the light diffuser when the light source is illuminated and the inner lens so as to cast light into the A/C interior.

2. The assembly of claim 1, wherein the illumination source is a cold cathode fluorescent tube or l.e.d.

3. The assembly of claim 2, wherein the cold cathode fluorescent tube is controlled by controllers accessible to a passenger seated adjacent to the assembly.

4. The assembly of claim 2, wherein the cold cathode fluorescent tube is controlled by controllers remote from the passenger.

5. The assembly of claim 4, wherein the cold cathode fluorescent tube is shaped to generally conform to the window opening.

6. The assembly of claim 1, wherein the A/C panel is curved and contains recessed walls adjacent the window opening.

7. The assembly of claim 6, wherein the illumination source is a cold cathode fluorescent tube; and wherein the cold cathode fluorescent tube is shaped to conform to the window opening but has slightly larger major and minor dimensions.

8. The assembly of claim 1, wherein the A/C interior panel is curved and walls adjacent the window opening taper inward, and wherein the inner collar is configured to lay adjacent the inward tapered walls such that the inner edge of the inner collar extends into the window opening.

9. The assembly of claim 8, wherein the shade of the window shade unit is pleated.

10. The assembly of claim 8, wherein the window shade unit is modular and self-contained.

11. The assembly of claim 5, wherein the inner collar includes recessed inward tapered walls and wherein the inner edge of the light diffuser is engaged near the outer edge of the collar.

12. The assembly of claim 6, wherein the light diffuser has recessed, inward tapered walls.

13. The assembly of claim 1, wherein the shade of the window unit is sealed between an outer and an inner lens and wherein the outer edge of the light diffuser lies adjacent the inner lens.

14. The assembly of claim 8, wherein the shade is electronically moveable between an open and a closed position and the controls therefor are positioned to lay adjacent a passenger seated near the window opening.

15. In an aircraft having an A/C exterior and an A/C interior, an assembly for illuminating an A/C window on the interior, the assembly comprising:
an A/C interior panel having an inner surface and an outer surface configured with walls defining a window opening;
a substantially opaque inner collar generally configured to the shape of the window opening having an inner edge and an outer edge;
a light diffuser configured to the shape of the window opening, the lid for engaging the opaque inner collar near the outer edge thereof;
a window unit having an inner lens and a substantially opaque shade;
coupling members to couple the window unit to the collar;
legs adjacent such that the light diffuser the window inner lens;
an illumination source configured to lay adjacent the collar, light diffuser, and the collar, the light diffuser so as to illuminate the window when the light source is illuminated and the inner lens so as to cast light when illuminated on the window and the A/C interior;
wherein the illumination source is a cold cathode fluorescent tube;
wherein the cold cathode fluorescent tube is controlled by controllers accessible to a passenger seated adjacent to the assembly;
wherein the cold cathode fluorescent tube is shaped to conform to the window opening but has smaller dimensions;
wherein the A/C panel is curved and contains recessed walls adjacent the window opening;
wherein the inner collar includes recessed inward tapered walls and wherein the inner edge of the light diffuser is engaged near the outer edge of the collar;
wherein the light diffuser has recessed, inward tapered walls;
wherein the shade of the window unit is sealed between an outer and an inner lens and wherein the outer edge of the light diffuser lies adjacent the inner lens; and
wherein the shade is electronically moveable between an open and a closed position and the controls therefor are positioned to lay adjacent a passenger seated near the window opening.

16. An aircraft having:
a body having a fuselage and wings, tail, and power source;
wherein the fuselage includes an aircraft interior, the aircraft interior having multiple windows and multiple window illumination assemblies, each assembly comprising:
an A/C interior panel having an inner surface and an outer surface configured with walls defining a window opening;
a substantially opaque inner collar generally configured to the shape of the window opening having an inner edge and an outer edge, the inner collar adapted to engage the A/C interior panel adjacent the window opening;
a window shade unit having an inner lens and a substantially opaque moveable shade;
a light diffuser member configured to the shape of the window opening, the light diffuser for engaging the opaque inner collar near the outer edge thereof and to lay adjacent the inner lens of the window shade unit;
coupling members to couple the window unit to the inner collar; and
an illumination source configured to lay adjacent the collar and an outer surface of the light diffuser, so as to illuminate the window from the outside in, through the light diffuser when the light source is illuminated and the inner lens so as to cast light into the A/C interior.
